(19) United States
(12) Patent Application Publication
(10) Pub. No.: US 2025/0191116 A1
(43) Pub. Date: Jun. 12, 2025

(54) ZOOM EFFECT GENERATING METHOD AND APPARATUS, DEVICE, AND STORAGE MEDIUM

(71) Applicant: Beijing Zitiao Network Technology Co., Ltd., Haidian District, Beijing (CN)

(72) Inventors: Luwei ZHANG, Beijing (CN); Xueke TANG, Beijing (CN); Zhanhong YE, Beijing (CN)

(21) Appl. No.: 18/843,583

(22) PCT Filed: Feb. 22, 2023
(86) PCT No.: PCT/CN2023/077636

§ 371 Date: Sep. 3, 2024

(30) Foreign Application Priority Data
Mar. 3, 2022 (CN) 202210204603.8

(51) Int. Cl. G06T 3/40; G06T 5/50

(52) U.S. Cl. CPC G06T 3/40; G06T 5/50; G06T 2207/20132; G06T 2207/20221

(57) ABSTRACT

A zoom effect generating method and apparatus, a device, and a storage medium. The method includes acquiring a zoom target and a zoom parameter set by a user in an interface of an effect tool, wherein the zoom parameter includes a range of zoom ratio, a zoom duration, and a zoom mode; performing a target detection on a video to be processed; and in response to the zoom target being detected, performing zoom processing on the video to be processed according to the zoom parameter to obtain a zoom effect video.

This application claims priority to the Chinese patent application No. 202210204603.8 filed with the CNIPA on Mar. 3, 2022, the disclosure of which is incorporated herein in its entirety by reference.

### TECHNICAL FIELD

Embodiments of the present disclosure relate to the technical field of image processing technology, for example, to a zoom effect generating method and apparatus, a device, and a storage medium.

### BACKGROUND

At present, for traditional effect tools, developers need to write shader codes to achieve effects. However, the writing of shader codes requires for high level of skills and is extremely unfriendly to tool users. Moreover, the existing effect tools only have a single zoom function, which results in a simple effect as generated and poor user experience.

### SUMMARY

Embodiments of the present disclosure provide a zoom effect generating method and apparatus, a device, and a storage medium.

In a first aspect, an embodiment of the present disclosure provides a zoom effect generating method, including:
acquiring a zoom target and a zoom parameter set by a user in an interface of an effect tool; wherein the zoom parameter includes a range of zoom ratio, a zoom duration, and a zoom mode;
performing a target detection on a video to be processed; and
in response to the zoom target being detected, performing zoom processing on the video to be processed according to the zoom parameter to obtain a zoom effect video.

In a second aspect, an embodiment of the present disclosure further provides a zoom effect generating apparatus, including:
a zoom parameter acquisition module, configured to acquire a zoom target and a zoom parameter set by a user in an interface of the effect tool; wherein the zoom parameter includes: a range of zoom ratio, a zoom duration, and a zoom mode;
a target detection module, configured to perform a target detection on a video to be processed; and
a zoom processing module, configured to perform a zoom processing on the video to be processed according to the zoom parameter in response to the zoom target being detected, to obtain a zoom effect video.

In a third aspect, an embodiment of the present disclosure further provides an electronic device, including:
one or more processing devices; and
a storage device configured to store one or more programs; wherein
the one or more programs, when executed by the one or more processing devices, are configured to cause the one or more processing devices to implement the zoom effect generating method as described in the embodiments of the present disclosure.

In a fourth aspect, an embodiment of the present disclosure further provides a computer-readable medium including a computer program stored thereon, wherein the computer program, when executed by a processing device, is configured to implement the zoom effect generating method as described in the embodiments of the present disclosure.

### BRIEF DESCRIPTION OF DRAWINGS

FIG. 1 is a flow chart of a zoom effect generating method in an embodiment of the present disclosure;

FIG. 2 is a schematic diagram of an interface of the effect tool in an embodiment of the present disclosure;

FIG. 3 is a schematic diagram of splicing a translated current video frame with a set material image in an embodiment of the present disclosure;

FIG. 4 is a schematic structural diagram of a zoom effect generating apparatus in an embodiment of the present disclosure; and

FIG. 5 is a schematic structural diagram of an electronic device in an embodiment of the present disclosure.

### DETAILED DESCRIPTION

Embodiments of the present disclosure will be described below with reference to the accompanying drawings. Although some embodiments of the present disclosure are shown in the drawings, it is to be understood that the present disclosure may be embodied in various forms and should not be construed as limited to the embodiments set forth herein, which rather are provided for a more thorough and complete understanding of the present disclosure. It is to be understood that the drawings and embodiments of the present disclosure are for illustrative purposes only and are not intended to limit the scope of disclosure.

It is to be understood that multiple steps described in the method implementations of the present disclosure may be executed in different orders and/or in parallel. Furthermore, the method embodiments may include additional steps and/or omit performing the illustrated steps. The scope of the present disclosure is not limited in this regard.

As used herein, the terms “comprise/include” and its variations are open-ended, i.e., “including but not limited to”. The term “based on” refers to “based at least in part on”. The term “an embodiment” refers to “at least one embodiment”; the term “another embodiment” refers to “at least one additional embodiment”; and the term “some embodiments” refers to “at least some embodiments”. Definitions of other terms will be given in the description below.

It is to be noted that concepts such as “first” and “second” mentioned in the present disclosure are only used to distinguish different devices, modules, or units, and are not used to limit the order of functions performed by these devices, modules, or units, or interdependences thereof.

It is to be noted that the modifiers such as “one” and “a plurality of” mentioned in the present disclosure are illustrative and are not limitative. Those skilled in the art will be appreciated that it should be understood as “one or more” unless the context clearly indicates otherwise.

The names of messages or information exchanged between multiple devices in the embodiments of the present disclosure are for illustrative purposes only and are not used to limit the scope of these messages or information.

FIG. 1 is a flow chart of a zoom effect generating method provided by an embodiment of the present disclosure. This embodiment can perform zoom processing on a video. The method can be executed by a zoom effect generating apparatus. The apparatus can be composed of hardware and/or software, and generally can be integrated into a device with the function of generating zoom effects. The device can be an electronic device, such as a server, a mobile terminal, or a server cluster. As shown in FIG. 1, the method includes the following steps.

S110: acquiring a zoom target and a zoom parameter set by a user in an interface of the effect tool.

The zoom parameter includes: a range of zoom ratio, a zoom duration, and a zoom mode. The zoom mode includes the number of cycles and the zoom trend in each cycle. The range of zoom ratio includes an initial zoom ratio and a target zoom ratio in one cycle. The zoom duration is a duration of one cycle. The zoom trend can include two aspects, which are the change trend of the zoom ratio and the change situation of the zoom speed. For example, the zoom ratio increases firstly and then decreases, and the zoom speed is faster during the zoom ratio increasing and slower during the zoom ratio decreasing; the zoom ratio increases firstly and then directly returns to the initial zoom ratio; the zoom ratio directly changes to the target zoom ratio and then gradually decreases, etc. In this embodiment, the user can select different zoom parameters to generate different zoom effects, so that the diversity of the zoom effects is improved.

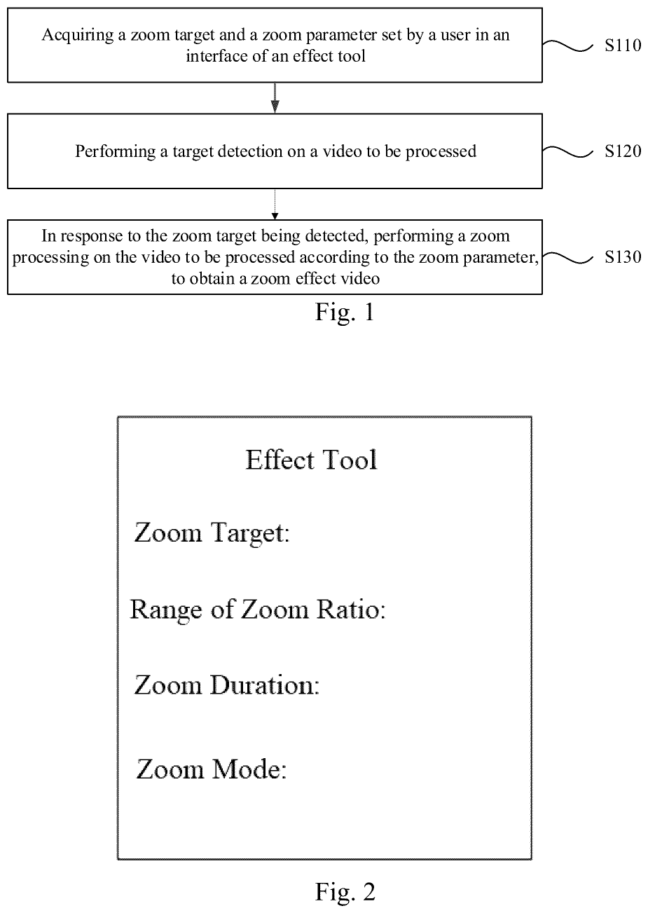

In this embodiment, the effect tool may be a program application (Application, APP) used to produce effect images or effect videos, or a tool embedded in the APP. Zoom parameter selection controls are provided in the interface of the effect tool, and users can set the desired zoom parameters by these controls. Exemplarily, FIG. 2 is a schematic diagram of an interface of the effect tool in this embodiment. As shown in FIG. 2, the interface includes a zoom target selection control, a zoom ratio range selection control, a zoom duration selection control, a zoom mode selection control and a drop-down box through which a zoom parameter selection control can be clicked, for example, a corresponding parameter can be selected from the drop-down box. For example, the range of zoom ratio is selected as 1.0-2.0, the zoom duration can be selected as 1.5 seconds, the number of cycles can be selected as 3 times, and the zoom trend may be the zoom ratio firstly increasing and then decreasing, with a faster zoom speed during the zoom ratio increasing and a slower zoom speed during the zoom ratio decreasing, etc.

The zoom target may be a target object selected arbitrarily by the user, for example, animals (such as cat faces, dog faces), human bodies (such as human limbs), human faces, etc.

S120, performing a target detection on a video to be processed.

The video to be processed may be a video collected in real time or a video that has been recorded, or a video downloaded from a local database or a server database. In this embodiment, any target detection algorithm in the related art can be used to detect the zoom target in the video to be processed.

For example, after the user sets the zoom target in the interface of the effect tool, a zoom target detection is performed on each video frame of the video to be processed.

In this embodiment, the process of performing a target detection on the video to be processed may include: during the playback of the video to be processed, performing a zoom target detection on a current video frame being played; if the zoom target is detected in the current video frame and is not detected in a previous video frame, starting timing from the current video frame to obtain a timing time corresponding to the current video frame; if the zoom target is detected in the current video frame and is detected in the previous video frame, adding a preset duration on a timing time corresponding to the previous video frame to obtain the timing time corresponding to the current video frame.

A playback process of the video to be processed can be understood as a process of recording a video of the current scene, or a process of playing a video having been recorded, or a process of playing a video which is downloaded. The zoom target being detected in the current video frame and the zoom target being not detected in the previous video frame can be understood in such a manner that, the zoom target appears for the first time in the current video frame or the zoom target appears again after disappearing for a period of time. In such case, the timing is started from the current video frame, and the timing time corresponding to the current video frame is obtained. The zoom target being detected in the current video frame and the zoom target being detected in the previous video frame can be understood in such a manner that, the zoom target appears in consecutive video frames. In such case, a preset duration is added to the timing time corresponding to the previous video frame to obtain the timing time corresponding to the current video frame. Among them, the preset duration can be determined by the frame rate of the video. Assuming that the frame rate of the video to be processed is f, then the preset duration is 1/f. In this embodiment, the timing time corresponding to the current video frame is obtained, so that the accuracy of determining the zoom ratio can be improved.

S130, in response to the zoom target being detected, performing a zoom processing on the video to be processed according to the zoom parameter, to obtain a zoom effect video.

In this embodiment, if a zoom target is detected in the video to be processed, a zoom ratio of the video frame containing the zoom target is determined according to the zoom parameters, and a zoom processing is performed on the video frame containing the zoom target according to the zoom ratio.

For example, the way of performing a zoom processing on the video to be processed according to the zoom parameters may include: determining the zoom ratio according to the timing time and the zoom parameters; and performing a zoom processing on the current video frame based on the zoom ratio.

The zoom ratio may be a ratio for scaling the video frame. For example, assuming that the zoom ratio is 1.5, then the video frame will be enlarged by 1.5 times. The timing time can be understood as the elapsed time from the start of timing to the current video frame. For example, if a zoom target is detected in the current video frame, the timing time corresponding to the current video frame is obtained, the zoom ratio is determined according to the timing time and the zoom parameters, and a zoom processing is performed on the current video frame according to the zoom ratio. In this embodiment, the zoom ratio is determined according to the timing time and the zoom parameters, and the zoom processing is performed on the current video frame based on the zoom ratio, which can improve the accuracy of the zoom processing.

For example, the way of determining the zoom ratio according to the timing time and the zoom parameters may include: determining a corresponding relationship between a cycle progress and the zoom ratio in one cycle based on the range of zoom ratio, the zoom duration, and the zoom trend; determining the cycle progress corresponding to the timing time according to the zoom duration and the number of cycles; and determining the zoom ratio corresponding to the cycle progress based on the corresponding relationship.

The cycle progress can be understood as the proportion, of a duration between the timing time corresponding to the current video frame and the start time of one cycle, occupied in a total duration of the one cycle. For example, assuming that the start time of a cycle is to, the end time is t1, and the timing time t2 corresponding to the current video frame is in this cycle, then the cycle progress is (t2−t0)/(t1−t0).

For example, the way of determining the corresponding relationship between the cycle progress and the zoom ratio in one cycle based on the range of zoom ratio, the zoom duration, and the zoom trend may include: firstly, determining a number of the video frames included in one cycle according to the zoom duration and the frame rate, then determining a change in zoom ratio between adjacent video frames in one cycle according to the zoom trend, finally, determining the zoom ratio of each video frame according to an initial zoom ratio in the range of zoom ratio and the change in zoom ratio, and determining the cycle progress of each video frame, thereby obtaining the corresponding relationship between the cycle progress and zoom ratio. Exemplarily, assuming that the range of zoom ratio is k1−k2, the zoom duration is T, the zoom trend is to firstly gradually increase the zoom ratio in a step length of k and then gradually increase the zoom ratio in a step length of k/2, and the frame rate is f; then the number of the video frames included in one cycle is Tf, the zoom ratios of various video frames sequentially are: k1+k, k1+2k, . . . k1+nk, k1+nk+k/2, . . . , k2, and finally the cycle progress corresponding to each video frame can be obtained, thereby obtaining the corresponding relationship between the cycle progress and the zoom ratio.

For example, the way of determining the cycle progress corresponding to the timing time according to the zoom duration and the number of cycles may include: determining whether the timing time is in a zoom cycle according to the zoom duration and the number of cycles; if it's in a zoom cycle, acquiring a period of time corresponding to a cycle where the timing time is located, wherein the period of time includes a start time and an end time; determining the cycle progress corresponding to the timing time based on the period of time.

In this embodiment, the zoom duration is multiplied by the number of cycles to obtain a total duration, and the timing time is compared with the total duration. If the timing time is greater than the total duration, the current video frame is not in a zoom cycle, that is, no zoom processing is performed on the current video frame. If the timing time is less than the total duration, the current video frame is in a zoom cycle, that is, a zoom processing is performed on the current video frame.

The way of acquiring the period of time corresponding to the cycle where the timing time is located may include: firstly, determining a period of time corresponding to each cycle according to the zoom duration, and then determining the period of time in which the timing time corresponding to the current video frame is located, thereby acquiring the cycle where the timing time is located. For example, assuming that the zoom duration is T and the number of cycles is 3, then the period of time of a first cycle is 0−T, the period of time of a second cycle is T−2T, and the period of time of a third cycle is 2T−3T; if the timing time of the current video frame is t1 and t1 is between T and 2T, the timing time of the current video frame is in the second cycle.

The way of determining the cycle progress corresponding to the timing time based on the period of time may include: calculating a ratio of, a duration between the timing time corresponding to the current video frame and the start time of the period of time corresponding to the timing time, to the zoom duration. For example, assuming that the timing time corresponding to the current video frame is located in a period of time of T−2T, and the timing time t2 corresponding to the current video frame is in this cycle, then the cycle progress is (t2−T)/T. In this embodiment, the accuracy of determining the zoom ratio can be improved.

The zoom processing can be understood as: performing an operation of enlarging or reducing (a scaling operation) a zoom object. In this embodiment, the way of performing a zoom processing on the current video frame based on the zoom ratio may include: performing a zoom processing on only the zoom target, or performing a zoom processing on the entire video frame.

In an embodiment, the way of performing a zoom processing on the current video frame based on the zoom ratio may include: extracting the zoom target from the current video frame to obtain a background image and a zoom target image; scaling the zoom target image by the zoom ratio; translating the scaled zoom target image so that a zoom point moves to a set position; and superimposing the translated zoom target image with the background image to obtain a target video frame.

The zoom point is a set point on the zoom target, such as a center point of the zoom target. For example, assuming that the zoom target is a human face, then the zoom point can be a pixel point on the tip of the nose. The set position can be a center point of the picture where the current video frame is located. For example, translating the scaled zoom target so that the tip of the nose moves to the center point of the picture where the video frame is located.

In this embodiment, the process of extracting the zoom target from the current video frame may include: detecting the zoom target in the current video frame to obtain a target detection box, and cutting the zoom target out of the current video frame according to the target detection box to obtain the zoom target image and the background image.

The background image is the image with the zoom target cut out. After scaling and translating the zoom target image, if directly superimposing it with the background image, a blank area may appear. Therefore, the background image needs to be restored firstly.

For example, the process of superimposing the translated zoom target image with the background image to obtain the target video frame may include: performing image restoration on the background image; and superimposing the translated zoom target image with the restored background image to obtain the target video frame.

The way of performing image restoration on the background image may include: inputting the background image into a set restoration model, and outputting the restored background image. The set restoration model can be obtained by training a set neural network model through using a large number of samples. The way of superimposing the translated zoom target image with the restored background image may include: superimposing the translated zoom target image on the restored background image to obtain the target video frame.

In an embodiment, the way of performing a zoom processing on the current video frame based on the zoom ratio may include: scaling the current video frame by the zoom ratio; and translating the scaled current video frame so that the zoom point moves to a set position.

The zoom point is a set point on the zoom target, such as the center point of the zoom target. For example, assuming that the zoom target is a human face, then the zoom point can be a pixel point on the tip of the nose. The set position can be the center point of the picture where the current video frame is located.

For example, reducing or enlarging the current video frame by a given zoom ratio, and then translating the scaled current video frame so that the zoom point moves to the center of the picture where the video frame is located.

In an embodiment, after translating the scaled current video frame, the following steps are also included: if the current video frame is enlarged by the zoom ratio, trimming the translated current video frame to obtain a target video frame, so that the target video frame has a same size as the current video frame before it's enlarged; if the current video frame is reduced by the zoom ratio, splicing the translated current video frame with a set material image to obtain a target video frame, so that the target video frame has a same size as the current video frame before it's reduced.

The set material image may be a material image generated based on the current video frame, or a material image randomly selected from a material library.

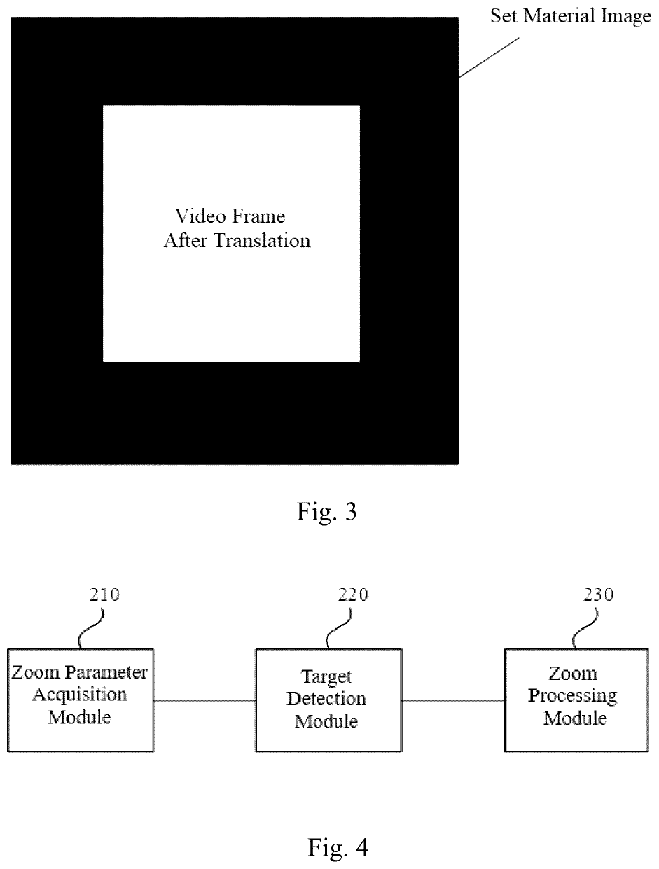

In this embodiment, the size of the picture where the current video frame is located is fixed. If the current video frame is enlarged by the zoom ratio and translated, a part of the image will overflow the current picture, and this part of the image overflowing the picture needs to be trimmed off. If the current video frame is reduced by the zoom ratio and translated, a blank area will appear in the current picture, and it needs to acquire a set material image corresponding to the blank area and splice the set material image with the translated current video frame to obtain the target video frame. Exemplarily, FIG. 3 is a schematic diagram of splicing the translated current video frame with the set material image in this embodiment. As shown in FIG. 3, the translated current video frame is located in the central area, and the black area at the periphery is the set material image.

In this embodiment, the scaled video frame or the scaled zoom target is translated so that the zoom point moves to the set position, which allows to present an effect that the zoom target is translated to the center of the picture as the zoom target is scaled.

In the embodiment of the present disclosure, the zoom target and the zoom parameters set by the user in the interface of the effect tool are acquired, the zoom parameters include: a range of zoom ratio, a zoom duration, and a zoom mode; a target detection is performed on the video to be processed; if the zoom target is detected, the zoom processing is performed on the video to be processed according to the zoom parameters to obtain a zoom effect video. The zoom effect generating method provided by embodiments of the present disclosure performs the zoom effect processing on videos based on the zoom parameters selected by users, which not only can increase the generation efficiency of zoom effects but also can improve the diversity of zoom effects.

FIG. 4 is a schematic structural diagram of a zoom effect generating apparatus disclosed in an embodiment of the present disclosure. As shown in FIG. 4, the apparatus includes:
a zoom parameter acquisition module 210, configured to acquire a zoom target and a zoom parameter set by a user in an interface of an effect tool; wherein the zoom parameter includes: a range of zoom ratio, a zoom duration, and a zoom mode;
a target detection module 220, configured to perform a target detection on a video to be processed; and
a zoom processing module 230, configured to perform a zoom processing on the video to be processed according to the zoom parameter when a zoom target is detected, to obtain a zoom effect video.

In an embodiment, the target detection module 220 is further configured to:
perform a zoom target detection on a current video frame being played during a playback of the video to be processed;
start timing from the current video frame to obtain a timing time corresponding to the current video frame, if the zoom target is detected in the current video frame and the zoom target is not detected in a previous video frame;
add a set duration on a timing time corresponding to the previous video frame to obtain the timing time corresponding to the current video frame, if the zoom target is detected in the current video frame and the zoom target is detected in the previous video frame.

In an embodiment, the zoom processing module 230 is further configured to:
determine a zoom ratio according to the timing time and the zoom parameter; and
perform a zoom processing on the current video frame based on the zoom ratio.

In an embodiment, the zoom mode includes a number of cycles and a zoom trend in each cycle; the range of zoom ratio includes an initial zoom ratio and a target zoom ratio in one cycle; and the zoom duration is a duration of one cycle.

In an embodiment, the zoom processing module 230 is further configured to:
determine a corresponding relationship between a cycle progress and the zoom ratio in one cycle based on the range of zoom ratio, the zoom duration, and the zoom trend;
determine the cycle progress corresponding to the timing time according to the zoom duration and the number of cycles; and
determine the zoom ratio corresponding to the cycle progress based on the corresponding relationship.

In an embodiment, the zoom processing module 230 is further configured to:
determine whether the timing time is in a zoom cycle according to the zoom duration and the number of cycles;
acquire a period of time corresponding to the cycle where the timing time is located if the timing time is in a zoom cycle; wherein the period of time includes a start time and an end time;
and

determine the cycle progress corresponding to the timing time based on the period of time.

In an embodiment, the zoom processing module 230 is further configured to:
extract the zoom target from the current video frame to obtain a background image and a zoom target image;
scale the zoom target image by the zoom ratio;
translate the scaled zoom target image so that a zoom point moves to a set position;
wherein the zoom point is a set point on the zoom target; and
superimpose the translated zoom target image with the background image to obtain a target video frame.

In an embodiment, the zoom processing module 230 is further configured to:
perform image restoration on the background image;
superimpose the translated zoom target image with the restored background image to obtain the target video frame.

In an embodiment, the zoom processing module 230 is further configured to:
scale the current video frame by the zoom ratio;
translate the scaled current video frame so that a zoom point moves to a set position;
wherein the zoom point is a set point on the zoom target.

In an embodiment, the zoom processing module 230 is further configured to:
trim the translated current video frame to obtain a target video frame if the current video frame is enlarged by the zoom ratio, so that the target video frame has a same size as the current video frame before enlarged; and
splice the translated current video frame with a set material image to obtain a target video frame if the current video frame is reduced by the zoom ratio, so that the target video frame has a same size as the current video frame before reduced.

The above-described apparatus can execute the method provided by any of the foregoing embodiments of the present disclosure, and has corresponding functional modules for executing the above-described method and corresponding beneficial effects. For the technical details that are not described specifically in this embodiment, reference can be made to the method provided by any of the foregoing embodiments of the present disclosure.

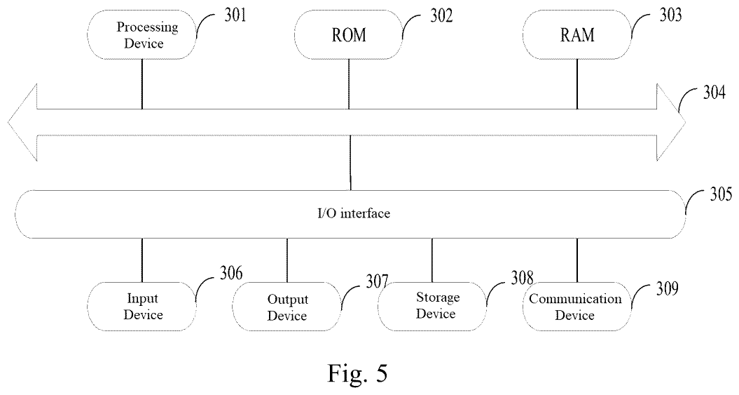

Referring now to FIG. 5, a schematic structural diagram of an electronic device 300 suitable for implementing embodiments of the present disclosure is shown. The electronic device in the embodiments of the present disclosure may include, but be not limited to, mobile terminals such as mobile phones, laptops, digital broadcast receivers, personal digital assistants (PDAs), Tablets (PADs), portable multimedia players (PMPs), vehicle-mounted terminals (such as vehicle-mounted navigation terminals), etc., and regular terminals such as digital televisions (TVs), desktop computers, etc., or various forms of servers such as independent servers or server clusters. The electronic device shown in FIG. 5 is only an example and should not impose any limitations on the functions and scope of usage of the embodiments of the present disclosure.

As shown in FIG. 5, the electronic device 300 may include a processing device (such as a central processing unit, a graphics processor, etc.) 301, which can execute various appropriate actions and processes according to a program stored in a read-only memory (ROM) 302 or a program loaded from a storage device 308 to a random-access memory (RAM) 303. In the RAM 303, various programs and data required for the operation of the electronic device 300 are also stored. The processing device 301, the ROM 302, and the RAM 303 are connected with each other via a bus 304. An input/output (I/O) interface 305 is also connected to the bus 304.

Generally, the following devices may be connected to the I/O interface 305: an input device 306 including, for example, a touch screen, a touch pad, a keyboard, a mouse, a camera, a microphone, an accelerometer, a gyroscope, etc.; an output device 307 including, for example, a liquid crystal display (LCD), a speaker, a vibrator, etc.; a storage device 308 including, for example, a magnetic tape, a hard disk, etc.; and a communication device 309. The communication device 309 may allow the electronic device 300 to communicate wirelessly or in a wired manner with other devices to exchange data. Although FIG. 5 illustrates electronic device 300 provided with various devices, it is to be understood that it is not required of implementation or availability of all the illustrated devices. More or fewer devices may alternatively be implemented or provided.

In particular, according to embodiments of the present disclosure, the processes described above with reference to the flowcharts may be implemented as computer software programs. For example, embodiments of the present disclosure include a computer program product including a computer program carried on a computer-readable medium, the computer program containing program codes for performing the method illustrated in the flowcharts. In these embodiments, the computer program may be downloaded and installed from the network via the communication device 309, or installed from the storage device 308, or installed from the ROM 302. When the computer program is executed by the processing device 301, the above-mentioned functions defined in the method of the embodiments of the present disclosure are performed.

It is to be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any computer-readable medium other than the computer-readable storage medium. The computer-readable signal medium may send, propagate or transmit a program used by or in combination with an instruction execution system, apparatus, or device. The program code contained on the computer-readable medium may be transmitted by using any suitable medium, including but not limited to an electric wire, a fiber-optic cable, radio frequency (RF) and the like, or any appropriate combination of them.

In some embodiments, the client and the server may communicate with any network protocol currently known or to be researched and developed in the future such as hypertext transfer protocol (HTTP), and may be interconnected with digital data communication (e.g., communication networks) in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs. When the one or more programs are executed by the electronic device, the electronic device is configured to: acquire a zoom target and a zoom parameter set by a user in an interface of the effect tool, wherein the zoom parameter includes: a range of zoom ratio, a zoom duration, and a zoom mode; perform a target detection on a video to be processed; and perform a zoom processing on the video to be processed according to the zoom parameter when a zoom target is detected, to obtain a zoom effect video.

The storage medium may be a non-transitory storage medium.

Computer program codes for performing the operations of the present disclosure may be written in one or more programming languages or a combination thereof, including but not limited to object-oriented programming languages such as Java, Smalltalk, C++, and conventional procedural programming languages such as “C” or similar programming languages. The program codes may be executed entirely on the user's computer, partly on the user's computer, as a stand-alone software package, partly on the user's computer and partly on a remote computer, or entirely on a remote computer or server. In situations involving remote computers, the remote computer can be connected to the user's computer through any kind of network, including a local area network (LAN) or a wide area network (WAN), or it can be connected to an external computer (such as an Internet service provider through Internet connection).

The flowcharts and block diagrams in the figures illustrate the architecture, functionality, and operations of possible implementations of systems, methods, and computer program products according to various embodiments of the present disclosure. In this regard, each block in the flowchart or block diagrams may represent a module, a program frame, or a portion of code which contains one or more executable instructions for implementing specified logic functions. It is also to be noted that, in some alternative implementations, the functions labeled in the block may be performed in a sequence different from those labeled in the figures. For example, two blocks shown one after another may actually be executed substantially in parallel, or they may sometimes be executed in a reverse order, depending on the functionality involved. It will also be noted that each block of the block diagram and/or flowchart, and combinations of blocks in the block diagram and/or flowchart illustration, can be implemented by special purpose hardware-based systems that perform the specified functions or operations, or can be implemented by using a combination of specialized hardware and computer instructions.

The units involved in the embodiments of the present disclosure can be implemented in software or hardware. Among them, the name of the unit/module does not constitute a limitation on the unit itself under certain circumstances.

The functions described above in the present disclosure may be performed, at least in part, by one or more hardware logic components. For example, and without limitation, exemplary types of hardware logic components that may be used include: Field Programmable Gate Arrays (FPGAs), Application Specific Integrated Circuits (ASICs), Application Specific Standard Products (ASSPs), Systems on Chips (SOCs), Complex Programmable Logical device (CPLD) and so on.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. Machine-readable medium may include, but not limited to, electronic, magnetic, optical, electromagnetic, infrared, or semiconductor systems, apparatuses or devices, or any suitable combination of the foregoing. More specific examples of machine-readable storage medium may include one or more wire-based electrical connections, laptop disks, hard drives, random access memory (RAM), read only memory (ROM), erasable programmable read only memory (EPROM or flash memory), optical fiber, portable compact disk read-only memory (CD-ROM), optical storage device, magnetic storage device, or any suitable combination of the above.

According to one or more embodiments of the present disclosure, the present disclosure discloses a zoom effect generating method, including:
acquiring a zoom target and a zoom parameter set by a user in an interface of an effect tool; wherein the zoom parameter includes a range of zoom ratio, a zoom duration, and a zoom mode;
performing a target detection on a video to be processed; and
in response to the zoom target being detected, performing a zoom processing on the video to be processed according to the zoom parameter to obtain a zoom effect video.

In an embodiment, performing a target detection on the video to be processed includes:
during a playback of the video to be processed, detecting the zoom target in a current video frame being played; and
in response to the zoom target being detected in the current video frame and the zoom target being not detected in a previous video frame, starting timing from the current video frame to obtain a timing time corresponding to the current video frame;
in response to the zoom target being detected in the current video frame and the zoom target being detected in the previous video frame, adding a set duration on a timing time corresponding to the previous video frame to obtain the timing time corresponding to the current video frame.

In an embodiment, performing a zoom processing on the video to be processed according to the zoom parameter includes:
determining a zoom ratio according to the timing time and the zoom parameter; and
performing zoom processing on the current video frame based on the zoom ratio.

In an embodiment, the zoom mode includes a number of cycles and a zoom trend in each cycle; the range of zoom ratio includes an initial zoom ratio and a target zoom ratio in one cycle; and the zoom duration is a duration of one cycle.

In an embodiment, determining the zoom ratio according to the timing time and the zoom parameter includes:
determining a corresponding relationship between a cycle progress and the zoom ratio in one cycle based on the range of zoom ratio, the zoom duration, and the zoom trend;
determining the cycle progress corresponding to the timing time according to the zoom duration and the number of cycles; and
determining the zoom ratio corresponding to the cycle progress based on the corresponding relationship.

In an embodiment, determining the cycle progress corresponding to the timing time according to the zoom duration and the number of cycles includes:
determining whether the timing time is in a zoom cycle according to the zoom duration and the number of cycles;
in response to the timing time being in the zoom cycle, acquiring a period of time corresponding to the cycle in which the timing time is located; wherein the period of time includes a start time and an end time; and
determining the cycle progress corresponding to the timing time based on the period of time.

In an embodiment, performing a zoom processing on the current video frame based on the zoom ratio includes:
extracting the zoom target from the current video frame to obtain a background image and a zoom target image;
scaling the zoom target image by the zoom ratio;
translating the scaled zoom target image so that a zoom point moves to a set position, wherein the zoom point is a set point on the zoom target; and
superimposing the translated zoom target image with the background image to obtain a target video frame.

In an embodiment, superimposing the translated zoom target image with the background image to obtain the target video frame, including:
performing image restoration on the background image; and
superimposing the translated zoom target image with the restored background image to obtain the target video frame.

In an embodiment, performing a zoom processing on the current video frame based on the zoom ratio includes:
scaling the current video frame by the zoom ratio; and
translating the scaled current video frame so that a zoom point moves to a set position, wherein the zoom point is a set point on the zoom target.

In an embodiment, after translating the scaled current video frame, further including:
in response to enlarging the current video frame by the zoom ratio, trimming the translated current video frame to obtain a target video frame such that the target video frame has a same size as the current video frame before enlarging; and
in response to reducing the current video frame by the zoom ratio, splicing the translated current video frame with a set material image to obtain the target video frame such that the target video frame has a same size as the current video frame before reducing.

The present disclosure is not limited to the specific embodiments described herein, and various changes, readjustments, and substitutions can be made without departing from the scope of the present disclosure. Therefore, although the present disclosure has been described through the above embodiments, the present disclosure is not limited to the above embodiments. Without departing from the concept of the present disclosure, more equivalent embodiments may also be included, and the scope of the present disclosure is defined by the scope of the attached claims.

What is claimed is:

1. A zoom effect generating method, comprising:
acquiring a zoom target and a zoom parameter set by a user in an interface of an effect tool; wherein the zoom parameter comprises a range of zoom ratio, a zoom duration, and a zoom mode;
performing a target detection on a video to be processed; and
in response to the zoom target being detected, performing a zoom processing on the video to be processed according to the zoom parameter to obtain a zoom effect video.

2. The method according to claim 1, wherein the performing a target detection on the video to be processed comprises:
during a playback of the video to be processed, detecting the zoom target in a current video frame being played; and
in response to the zoom target being detected in the current video frame and the zoom target being not detected in a previous video frame, starting timing from the current video frame to obtain a timing time corresponding to the current video frame;
in response to the zoom target being detected in the current video frame and the zoom target being detected in the previous video frame, adding a set duration on a timing time corresponding to the previous video frame to obtain the timing time corresponding to the current video frame.

3. The method according to claim 2, wherein performing a zoom processing on the video to be processed according to the zoom parameter comprises:
determining a zoom ratio according to the timing time and the zoom parameter; and
performing a zoom processing on the current video frame based on the zoom ratio.

4. The method according to claim 1, wherein
the zoom mode comprises a number of cycles and a zoom trend in each cycle,
the range of zoom ratio comprises an initial zoom ratio and a target zoom ratio in one cycle; and
the zoom duration is a duration of one cycle.

5. The method according to claim 4, wherein determining the zoom ratio according to the timing time and the zoom parameter comprises:
determining a corresponding relationship between a cycle progress and the zoom ratio in one cycle based on the range of zoom ratio, the zoom duration, and the zoom trend;
determining the cycle progress corresponding to the timing time according to the zoom duration and the number of cycles; and
determining the zoom ratio corresponding to the cycle progress based on the corresponding relationship.

6. The method according to claim 5, wherein determining the cycle progress corresponding to the timing time according to the zoom duration and the number of cycles comprises:
determining whether the timing time is in a zoom cycle according to the zoom duration and the number of cycles;
in response to the timing time being in the zoom cycle, acquiring a period of time corresponding to the cycle in which the timing time is located; wherein the period of time comprises a start time and an end time; and
determining the cycle progress corresponding to the timing time based on the period of time.

7. The method according to claim 3, wherein performing a zoom processing on the current video frame based on the zoom ratio comprises:
extracting the zoom target from the current video frame to obtain a background image and a zoom target image;
scaling the zoom target image by the zoom ratio;
translating the scaled zoom target image so that a zoom point moves to a set position, wherein the zoom point is a set point on the zoom target; and
superimposing the translated zoom target image with the background image to obtain a target video frame.

8. The method according to claim 7, wherein superimposing the translated zoom target image with the background image to obtain the target video frame, comprising:
performing image restoration on the background image; and
superimposing the translated zoom target image with the restored background image to obtain the target video frame.

9. The method according to claim 3, wherein performing a zoom processing on the current video frame based on the zoom ratio comprises:
scaling the current video frame by the zoom ratio; and
translating the scaled current video frame so that a zoom point moves to a set position, wherein the zoom point is a set point on the zoom target.

10. The method according to claim 9, after translating the scaled current video frame, further comprising:
in response to enlarging the current video frame by the zoom ratio, trimming the translated current video frame to obtain a target video frame such that the target video frame has a same size as the current video frame before enlarging; and
in response to reducing the current video frame by the zoom ratio, splicing the translated current video frame with a set material image to obtain the target video frame such that the target video frame has a same size as the current video frame before reducing.

11. (canceled)

12. An electronic device, comprising:
one or more processing devices; and
a storage device configured to store one or more programs; wherein
the one or more programs, when executed by the one or more processing devices, are configured to cause the one or more processing devices to implement a zoom effect generating method, comprising:
acquiring a zoom target and a zoom parameter set by a user in an interface of an effect tool; wherein the zoom parameter comprises a range of zoom ratio, a zoom duration, and a zoom mode;
performing a target detection on a video to be processed; and
in response to the zoom target being detected, performing a zoom processing on the video to be processed according to the zoom parameter to obtain a zoom effect video.

13. A computer-readable medium comprising a computer program stored thereon, wherein the computer program, when executed by a processing device, is configured to implement a zoom effect generating method, comprising:
acquiring a zoom target and a zoom parameter set by a user in an interface of an effect tool; wherein the zoom parameter comprises a range of zoom ratio, a zoom duration, and a zoom mode;
performing a target detection on a video to be processed; and
in response to the zoom target being detected, performing a zoom processing on the video to be processed according to the zoom parameter to obtain a zoom effect video.

14. The electronic device according to claim 12, wherein in the zoom effect generating method,
the performing a target detection on the video to be processed comprises:
during a playback of the video to be processed, detecting the zoom target in a current video frame being played; and
in response to the zoom target being detected in the current video frame and the zoom target being not detected in a previous video frame, starting timing from the current video frame to obtain a timing time corresponding to the current video frame;
in response to the zoom target being detected in the current video frame and the zoom target being detected in the previous video frame, adding a set duration on a timing time corresponding to the previous video frame to obtain the timing time corresponding to the current video frame.

15. The electronic device according to claim 14, wherein in the zoom effect generating method,
the performing a zoom processing on the video to be processed according to the zoom parameter comprises:
determining a zoom ratio according to the timing time and the zoom parameter; and
performing a zoom processing on the current video frame based on the zoom ratio.

16. The electronic device according to claim 12, wherein in the zoom effect generating method,
the zoom mode comprises a number of cycles and a zoom trend in each cycle,
the range of zoom ratio comprises an initial zoom ratio and a target zoom ratio in one cycle; and
the zoom duration is a duration of one cycle.

17. The electronic device according to claim 16, wherein in the zoom effect generating method,
the determining the zoom ratio according to the timing time and the zoom parameter comprises:
determining a corresponding relationship between a cycle progress and the zoom ratio in one cycle based on the range of zoom ratio, the zoom duration, and the zoom trend;
determining the cycle progress corresponding to the timing time according to the zoom duration and the number of cycles; and
determining the zoom ratio corresponding to the cycle progress based on the corresponding relationship.

18. The electronic device according to claim 17, wherein in the zoom effect generating method,
the determining the cycle progress corresponding to the timing time according to the zoom duration and the number of cycles comprises:
determining whether the timing time is in a zoom cycle according to the zoom duration and the number of cycles;
in response to the timing time being in the zoom cycle, acquiring a period of time corresponding to the cycle in which the timing time is located; wherein the period of time comprises a start time and an end time; and
determining the cycle progress corresponding to the timing time based on the period of time.

19. The electronic device according to claim 15, wherein in the zoom effect generating method,
the performing a zoom processing on the current video frame based on the zoom ratio comprises:
extracting the zoom target from the current video frame to obtain a background image and a zoom target image;
scaling the zoom target image by the zoom ratio;
translating the scaled zoom target image so that a zoom point moves to a set position, wherein the zoom point is a set point on the zoom target; and
superimposing the translated zoom target image with the background image to obtain a target video frame.

20. The electronic device according to claim 19, wherein in the zoom effect generating method,
the superimposing the translated zoom target image with the background image to obtain the target video frame, comprising:
performing image restoration on the background image; and
superimposing the translated zoom target image with the restored background image to obtain the target video frame.

21. The electronic device according to claim 15, wherein in the zoom effect generating method,
the performing a zoom processing on the current video frame based on the zoom ratio comprises:
scaling the current video frame by the zoom ratio; and
translating the scaled current video frame so that a zoom point moves to a set position, wherein the zoom point is a set point on the zoom target.
